(19) United States
(12) Patent Application Publication
(10) Pub. No.: US 2026/0270152 A1
(43) Pub. Date: Sep. 10, 2026

(54) METHODS AND APPARATUSES FOR DETERMINING ANOMALIES IN A DATA SET OF NETWORK PERFORMANCE METRICS

(71) Applicant: Telefonaktiebolaget LM Ericsson (publ), Stockholm (SE)

(72) Inventor: Ebenezer RHP ISAAC, Chennai (IN)

(21) Appl. No.: 19/165,551

(22) PCT Filed: Mar. 15, 2023
(86) PCT No.: PCT/IN2023/050244

§ 371 Date: Sep. 15, 2025

(51) Int. Cl. H04L 41/142; H04L 9/40; H04L 41/0816; H04W 24/02

(52) U.S. Cl. CPC H04L 41/142; H04L 41/0816; H04L 63/1425; H04W 24/02

(57) ABSTRACT

Embodiments described herein relate to a method and apparatus for determining anomalies in a data set of performance metrics from a network. A computer-implemented method comprises obtaining a first tail of the data set; obtaining a first percentage threshold; determining a first threshold by inputting the first percentage threshold into a percent point function of a standard normal distribution; and utilising the first threshold to determine whether values in the first tail of the data set are anomalous.

### TECHNICAL FIELD

Embodiments described herein relate to a method and apparatus for determining anomalies in a data set of network performance metrics.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Generally, the terms outliers and anomalies are used interchangeably. However, they may differ when considered in a business context. An outlier is a rare occurrence that differs significantly from the majority of data under observation. Whereas an anomaly is a significant deviation from the expected occurrence. Not all data points that are outliers conform as anomalies; it depends on the business use case. Hence, outlier detection looks at data from a statistical standpoint while anomaly detection (AD) considers it from a business perspective. When it comes to time series, AD becomes even more of a challenge due to seasonality and trend.

An AD pipeline for time series data is depicted in FIG. 1. First, the features 101 from the data 100 that relate to the anomalies under consideration are selected for processing. A pre-processing step 102 may involve feature engineering and then removal of seasonal components through seasonal decomposition such as STL (see for example, Rob J Hyndman and George Athanasopoulos, Forecasting: Principles and Practice Section 6.6 STL Decomposition, link: https://otexts.com/fpp2/stl.html). The pre-processed data is then fed to the outlier detection algorithm 103. Generally, an outlier detection algorithm 103 provides scores on top of which a threshold 104 is set to determine outliers. The anomalies are then filtered 105 (e.g., using some heuristic or rules) to provide anomalies 106 that fit the business need.

Determining a Z score is a method for outlier detection. A Z score for a given random variable X, is given by (X−μ)/σ. Where μ is the mean and σ is the standard deviation (SD). By definition, a Z Score calculation applied to univariate data is a transformation that converts the data to a standard normal distribution, i.e., a normal distribution with zero mean (μ=0) and unit standard deviation (σ=1). The Z score may range from −∞ to +∞. Finding an arbitrary anomaly threshold for a given use case is usually done by trial and error.

Upper thresholds are used to identify right-tailed outliers, i.e., values greater than which are outliers. Lower thresholds are used to identify left-tailed outliers, i.e., values lesser than which are outliers. Both these thresholds may be used in combination for a two-tailed outlier detection application. The Z score of a given data point shows how many multiples of the SD is the point away from the mean.

More computationally intensive methods do exist that claim to provide ideal results (see for example, Varun Chandola et al., Anomaly Detection: A Survey. in ACM computing surveys (CSUR) vol 41, no. 3 (2009): pp 1-58). Computationally efficient methods, such as the Z score, are preferred when working with large datasets where the response times are critical.

There may not be a single threshold that works for all AD problems as it depends on the nature of the data and the use case. It is entirely possible to have different thresholds operating on the same dataset for different use cases. Setting the right threshold is mostly not intuitive as it involves trial and error of an arbitrary number that makes little sense to the end user. There should also be a reasonable means to express the anomaly score to the user; a measure of criticality-answering the question, “To which degree is this instance anomalous?”

A typical dynamic thresholding method involves the use of percentiles of the scores of the training set for the thresholds. The upper dynamic threshold is based on a high percentile e.g., 99%, and the lower dynamic threshold can be based on a low percentile, e.g., 1%. Then, the following steps may then apply.
1. Scores=Z Score of the training dataset
2. The Z Score corresponding to the set percentiles become the respective upper and lower thresholds to detect outliers.
   a. upper_threshold=percentile (scores, upper_dynamic_threshold)
   b. lower_threshold=percentile (scores, lower_dynamic_threshold)
3. All values above upper_threshold and below the lower_threshold would be considered outliers.

### SUMMARY

A typical dynamic thresholding method as described above involves the use of percentiles of the scores of the training set for the thresholds. The upper dynamic threshold is based on a high percentile e.g., 99%, and the lower dynamic threshold may be based on a low percentile, e.g., 1%.

However, this method assumes that input data set will always contain anomalies. For instance, if the data set under observation consist of 100,000 samples and the dynamic thresholds were set as in the above example, then 2000 samples will always be anomalies according to this method regardless of their closeness to the expected range.

There are also several variants of the Z score available. A variation of Z score with K nearest neighbours is presented in one study (see V. Aggarwal, V. Gupta, P. Singh, K. Sharma and N. Sharma, “Detection of Spatial Outlier by Using Improved Z-Score Test,” 2019 3rd International Conference on Trends in Electronics and Informatics (ICOEI), Tirunelveli, India, 2019, pp. 788-790, doi: 10.1109/ICOEI.2019.8862582) to identify anomalies in two dimensions. It also does not estimate real value bounds. In another study (see Chikodili, N. B., Abdulmalik, M. D., Abisoye, O. A., Bashir, S. A. (2021). Outlier Detection in Multivariate Time Series Data Using a Fusion of K-Medoid, Standardized Euclidean Distance and Z-Score. In: Misra, S., Muhammad-Bello, B. (eds) Information and Communication Technology and Applications. ICTA 2020. Communications in Computer and Information Science, vol 1350. Springer, Cham) Z score was combined with multiple other methods for anomaly detection on multivariate time series data. Though the results in that paper discuss precision recall, f-measure and accuracy over a labelled dataset, methods to aid validation for an unlabelled dataset were not discussed. Though these methods claim to yield a high recall, they have much lower precision (<0.28) which may be considered unfavourable in telecom scenarios.

According to some embodiments there is provided a computer-implemented method for determining anomalies in a data set of performance metrics from a network. The method comprises obtaining a first tail of the data set; obtaining a first percentage threshold; determining a first threshold by inputting the first percentage threshold into a percent point function of a standard normal distribution; and utilising the first threshold to determine whether values in the first tail of the data set are anomalous.

According to some embodiments there is provided an apparatus for determining anomalies in a data set of performance metrics from a network. The apparatus comprising processing circuitry configured to cause the apparatus to: obtain a first tail of the data set; obtain a first percentage threshold; determine a first threshold by inputting the first percentage threshold into a percent point function of a standard normal distribution; and utilise the first threshold to determine whether values in the first tail of the data set are anomalous.

Aspects and examples of the present disclosure thus provide methods and apparatuses that enable improved anomaly detection in a data set of performance metrics.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 illustrates an anomaly detection pipeline for time series data;

FIG. 2 illustrates a computer-implemented method for determining anomalies in a data set of performance metrics from a network;

FIG. 3 illustrates an example of utilising the first threshold to determine whether values in the first tail of the data set are anomalous;

FIG. 4 illustrates an example of utilising the first threshold to determine whether values in the first tail of the data set are anomalous;

FIG. 5 illustrates an example implementation of the methods of FIGS. 2 to 4;

FIG. 6 illustrates Kurtosis in S1 Setup Failures—a cell performance management KPI;

FIG. 7 illustrates the effect of skew in the distribution of a KPI called DL PDCP Latency of two different cells over 2 months.

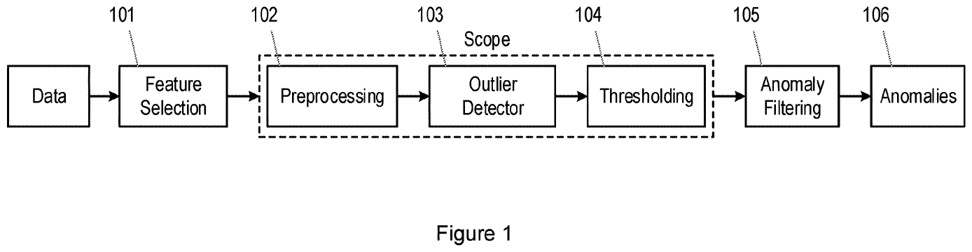

### DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

Certain aspects of the present disclosure and their embodiments may provide solutions to these or other challenges. The steps of any methods disclosed herein do not have to be performed in the exact order disclosed, unless a step is explicitly described as following or preceding another step and/or where it is implicit that a step must follow or precede another step.

Particular embodiments are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

In some embodiments described herein an input data set is filtered to minimize kurtosis and remove datapoints that skew the data distribution. Thresholds may then be obtained from a standard normal PPF so that the thresholds will not be dependent on the input data distribution. Separate thresholds may be used for the left tail and the right tail. The thresholds may be used to generate anomaly scores in percentages that may convey meaning to a typical end-user who views them. Alternatively, or additionally, the obtained thresholds may be converted to bounds on the real data so that the end-user can perceive the boundaries to differentiate normal data from anomalous data.

When used for time series AD, the embodiments described herein assume that necessary seasonality decomposition is applied and that the residuals are produced as input data for the sequences mentioned in the solution.

The solution described herein is based on univariate input, X. The normal operating value and real bounds are extracted by operating on X. However, embodiments described herein may be extended for use on multivariate time series data through a multi-univariate formulation, e.g., constructing a univariate model for each metric and using a domain-specific condition to combine anomalies from each variable. Multi-univariate models may be preferred to multivariate models as multivariate models throw outliers based on statistical joint-distribution which are difficult to evaluate and are potentially false positives.

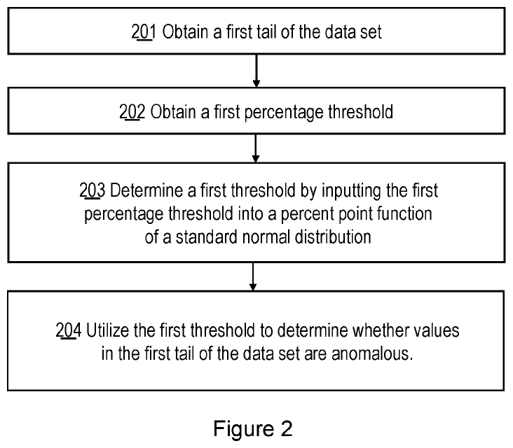

FIG. 2 illustrates a computer-implemented method for determining anomalies in a data set of performance metrics from a network.

The method 200 may be performed by a network node, which may comprise a physical or virtual node, and may be implemented in a computing device or server apparatus and/or in a virtualized environment, for example in a cloud, edge cloud or fog deployment. For example, the method of FIG. 2 may be performed in a node in one of: an application layer of the network or a session management layer of the network. It will be appreciated that the network node may be implemented anywhere in which monitoring of a time series signal is required for analysing anomalous patterns. In some examples, the method of FIG. 2 may be performed in a Service Management and Orchestration platform.

In step 201 the method comprises obtaining a first tail of the data set. The first tail may comprise an upper tail or a lower tail of the data set. It will be appreciated that in some cases the method of FIG. 2 can be performed separately for both tails of the data set.

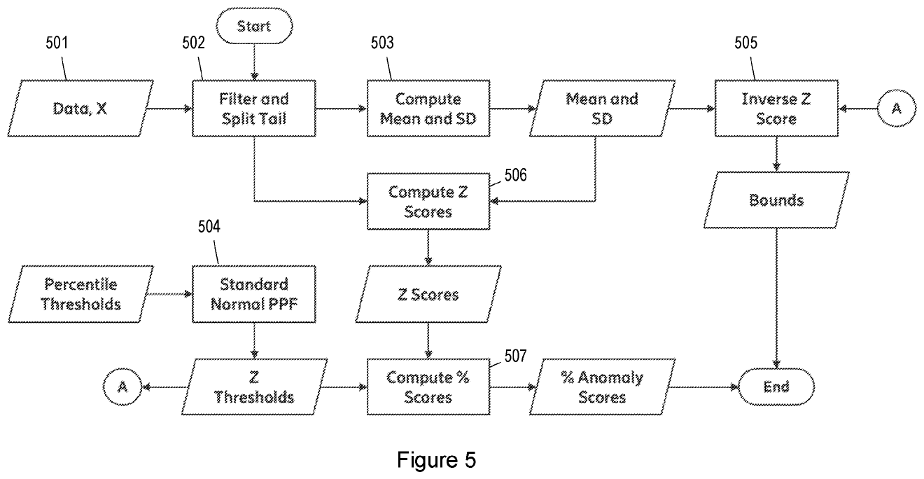

The first tail may be obtained in different ways as will be described in more detail layer with reference to FIG. 5.

In step 202 the method comprises obtaining a first percentage threshold. The first percentage threshold may comprise an input provided by a user or a configured default first percentage threshold. The first percentage threshold may indicate how sensitive the user wishes the anomaly detection to be.

In step 203 the method comprises determining a first threshold by inputting the first percentage threshold into a percent point function of a standard normal distribution.

It will therefore be appreciated that the first threshold is taken from the percentage point function (PPF) of the standard normal distribution as opposed to the Z-scores from the input data set. A PPF (also known as percentile function or quantile function) comprises an inverse of a cumulative distribution function (see for example, Taboga, Marco (2021). “Quantile of a probability distribution”, Lectures on probability theory and mathematical statistics. Kindle Direct Publishing). Although there is currently no analytical expression to calculate this function, numerical approximations do exist which work well for embodiments described herein. A Python implementation of PPF is provided by SciPy (see Reference documentation of scipy.stats.norm. https://docs.scipy.org/doc/scipy/reference/generated/scipy.stats.norm.html).

In other words, first threshold=standard_normal_PPF (first_perc_thresh).

For a right tail the first threshold may be referred to as an upper threshold. For a left tail the first threshold may be referred to as a lower threshold.

By utilising thresholds derived from the PPF rather than from the dataset itself, the method of FIG. 2 avoids having to assume that the dataset comprises anomalies. This therefore reduces the likelihood of falsely identifying data points as being anomalous.

In step 204 the method comprises utilising the first threshold to determine whether values in the first tail of the data set are anomalous.

In some examples, step 304 may comprise determining Z Scores for the values in the first tail of the data set. A Z-score computation is a transformation that converts the input data into unit variance and 0 mean, e.g., the standard normal distribution.

Step 204 may therefore comprise, if the first percentage threshold comprises an upper percentile threshold of 99%, and the first threshold taken from the PPF is zᵤ, then any Z-score for the values in the first tail above Zy may be considered an outlier of the distribution with 99% confidence.

In a similar manner, if the first percentage threshold comprises a lower percentile threshold of 1%, and the first threshold taken from the PPF is zᵤ, then any Z-score for the values in the first tail below zᵤ may be considered an outlier of the distribution with 99% confidence.

It will be appreciated that if the method of FIG. 2 is performed for both tails of the data set, then the method further comprises obtaining a second tail of the data set; obtaining a second percentage threshold; determining a second threshold by inputting the second percentage threshold into a percent point function of a standard normal distribution; and utilising the second threshold to determine whether values in the second tail of the data set are anomalous.

In some examples, the method of FIG. 2 further comprises responsive to determining that a number of anomalies in the first tail of the data set has increased (e.g., from a previously determined number of anomalies), initiating an identification of the cause of the increase. For example, an anomalous increase in failure KPIs that lead to anomalous dip in load KPIs could mean that a significant failure has occurred that lead to a degradation of the cell. Once the occurrence of the degradation is identified, the network operator may investigate the logs at the associated timestamps to identify the cause of the loss in network performance (root cause analysis). In another example, an anomalous dip in subscriber provisioning can mean that a recent rollout of an offer associated with an influencing subscription can be malfunctioning causing loss of provisioning and could potentially lead to customer churn if not addressed immediately.

In some examples, the method of FIG. 2 further comprises analysing a number of anomalies in the first tail of the data set to determine whether a cell in the network is inactive or sleeping. For example, anomaly detection may be used to assist in sleeping cell detection by identifying unusual network behaviours or fluctuations in network usage patterns. By analysing these deviations, anomaly detection may help determine when a cell may be inactive or sleeping, and help trigger an investigation into the cause of the behaviour.

In some examples, the method of FIG. 2 further comprises responsive to determining that a number of anomalies in the first tail of the data set has increased (e.g. from a previously determined number of anomalies), determining that a malicious attack has occurred in the network. For example, anomaly detection algorithms can be used to monitor telecom networks for security threats such as hacking, intrusion, and malware. By detecting unusual network behaviour, the system can respond to potential threats quickly and effectively.

In some examples, the method of FIG. 2 further comprises responsive to determining that a number of anomalies in the first tail of the data set has increased (e.g., from a previously determined number of anomalies), adjusting one or more network configuration parameters. Cell configuration parameters may have an effect on the user equipment connected to the cell, and this is indicated by a set of KPIs. Once these parameters are changed, it may have a net positive or negative effect on user experience depending on the anomalous activity on the KPIs. Negative occurrences may be identified as soon as possible for the cell to revert automatically to its previous configuration to minimize the loss of service.

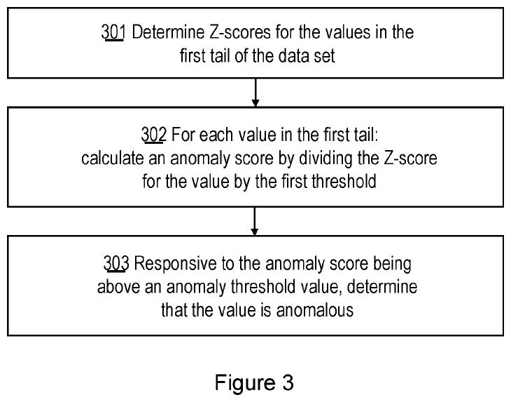

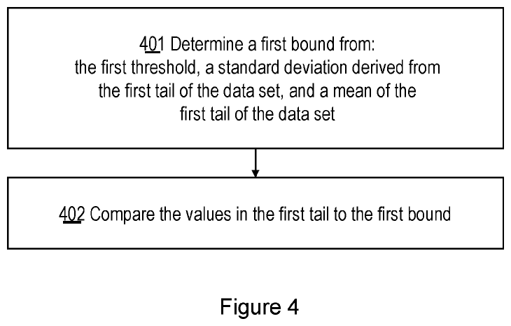

Examples of how step 204 may be performed as described in more detail with reference to FIGS. 3 and 4.

FIG. 3 illustrates an example of utilising the first threshold to determine whether values in the first tail of the data set are anomalous. FIG. 3 comprises an example implementation of step 204.

In step 301 the method comprises determining Z-scores for the values in the first tail of the data set.

For example, the Z-scores of a right tail, Zᵣ and a left tail, Zₗ may be calculated as follows:

$$Z score array of right tail , {Z}_{r} = ( {X}_{r} - {μ}_{r} ) / {σ}_{r}$$

$$Z score array of left tail , {Z}_{l} = ( {X}_{l} - {μ}_{l} ) / {σ}_{l}$$

Where Xᵣ are the values in the right tail, μᵣ is the mean of the right tail, σᵣ is the standard deviation of the right tail, Xₗ are the values in the left tail, μₗ is the mean of the left tail, σₗ is the standard deviation of the left tail.

In other words, Z scores may be generated from the mean and standard deviation of the respective tail.

In step 302, or each value in the first tail, the method comprises calculating an anomaly score by dividing the Z-score for the value by the first threshold.

The anomaly scores for a right tail, anomaly_scores, and a left tail, anomaly_scoresₗ, may be calculated as follows:

$${anomaly\_scores}_{r} = 100 \cdot {Z}_{r} / upper\_threshold$$

$${anomaly\_scores}_{l} = 100 \cdot {Z}_{l} / upper\_threshold$$

In step 303, responsive to the anomaly score being above an anomaly threshold value, determining that the value is anomalous. The anomaly threshold value may comprise for example 100%. In other words, when the anomaly score for a value reaches 100% it may be determined that the value is anomalous.

The anomaly scores for the values in the first tail may therefore be 0% from the start of the first tail (e.g., the values closest to the centre of the original data set distribution) up until the mean of the first tail. From the mean of the first tail the anomaly score may then scale up to 100% as it reaches the first threshold.

In some examples, the anomaly scores with a negative percentage may be capped at 0%. There may also be an option to cap the anomaly scores greater than 100% to 100%, depending on the business interest.

FIG. 4 illustrates an example of utilising the first threshold to determine whether values in the first tail of the data set are anomalous. FIG. 4 comprises an example implementation of step 204.

In step 401 the method comprises determining a first bound from: the first threshold, a standard deviation derived from the first tail of the data set, and a mean of the first tail of the data set.

For example, once a first threshold along with the mean and SD are obtained for a first tail, a bound for the first tail can be computed by taking the inverse of the Z score.

The following illustrates an example of how bounds may be calculated for both the right tail and the left tail. It will be appreciated that the first bound for the right tail may be referred to as an upper bound whereas the first bound for the left tail may be referred to as a lower bound.

Let zᵤ be the upper threshold, and μᵣ and or be the respective mean and SD calculated from the right tail, then the upper bound, xᵤ may be derived as follows.

$$( {x}_{u} - {μ}_{r} ) / {σ}_{r} = {z}_{u}$$

$$( {x}_{u} - {μ}_{r} ) = {z}_{u} {σ}_{r}$$

$${x}_{u} = {z}_{u} {σ}_{r} + {μ}_{r}$$

Similarly, the lower bound, xₗ, may given by

$${x}_{l} = {z}_{l} {σ}_{l} + {μ}_{l}$$

Where Zₗ is the lower threshold, and μₗ and or are the mean and SD of the left tail respectively.

For time series data, where only the residuals are provided as in the data set, the first bounds may be calculated by utilising an inverse of the operation that was used to compute the residuals. A typical residual computation in time series involves taking a difference between the observed value and the forecasted value, i.e., residual=observed-forecast. So, the first bound previously calculated correspond to the bounds on the residuals. In the example to determine a real data bound on the real data, the real data bound can be calculated by adding the forecast to the calculated first bound that corresponds to the residuals.

Step 402 may then comprise comparing the values in the first tail to the first bound.

For example, for the upper bound any value in the right tail greater than the upper bound may be considered an anomaly. In contrast, for the lower bound any value in the left tail lower than the lower bound may be considered an anomaly.

FIG. 5 illustrates an example implementation of the methods of FIGS. 2 to 4.

In FIG. 5 it is assumed that input is data in time series and three main artefacts are generated as output: Z-thresholds (both upper and lower depending on the configuration), percentage anomaly scores, and bounds. In this example, the Mean and standard deviation are only computed during the training sequence and the Z scores themselves are computed during the inference sequence.

Steps 501 to 505 may be considered training phase steps. Steps 506 to 507 may be considered to be inference phase steps.

In step 501 the input data, X, is filtered and split into a right tail and a left tail.

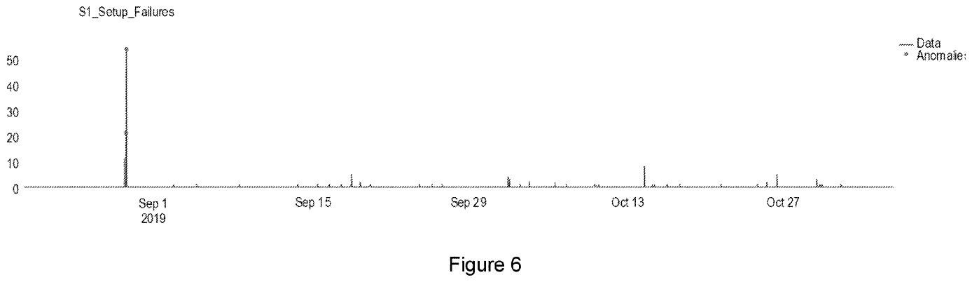

The data may be filtered to reduce kurtosis in the data set. In previous studies (see for example, Loperfido, Nicola. “Kurtosis-based projection pursuit for outlier detection in financial time series.” The European Journal of Finance 26.2-3 (2020): 142-164) the aim has been to maximize kurtosis based on the assumption that it would aid identifying outliers. However, this does not take into account data with a natural long tail that are commonly found in telecommunications scenarios (such as network KPIs). In certain cases, (especially monitoring KPIs) tend to have a long tail that should not be considered as outliers. Examples of scenarios in which the data natural occurs with a long tail are exhibited by failure KPIs such as S1 Setup Failures, Abnormal Releases MME, E-RAB Setup Failures, etc. An illustration of this phenomenon is provided in FIG. 6.

FIG. 6 illustrates Kurtosis in S1 Setup Failures—a cell performance management KPI. It can be seen that most of the datapoints are 0 (more than 75% in this case). According to the Z distribution, there is a 99.9% confidence that any value Z score of 3 is an outlier. In this case, only the highlighted 2 are supposed to be anomalies, but at least 20 other minor peaks in this graph also has a Z-score above 3 are hence considered to be outliers as well by this condition. The natural kurtosis in this distribution therefore causes the identification of false positives when simply using the Z-scores to identify anomalies.

A data set may be considered to have high kurtosis if a greater proportion of the data is equal to the mode average (for instance, >50% of the data is equal to the mode average). In these circumstances the standard deviation would become so small that a greater Z score would occur for even the slightest deviation, which would result in too many values being indicated as anomalies.

For example, step 501 may comprise reducing kurtosis in the data set by: responsive to a cardinality of a mode m, in the data set being greater than a mode elimination threshold m proportion of the data set, removing values from the data set equal to the mode to generate a reduced data set. In some examples, step 501 may then further comprise setting the reduced data set as the data set and repeating step the step of removing values from the data set if the cardinality of the mode, mₒ in the data set is greater than the model elimination threshold.

Let m be the mode elimination threshold (with 0.5 being a reasonable default) and mois the computed mode. Step 501 may therefore comprise, if the cardinality of the mode (e.g. the number of elements in the data set with the value of the mode) in the data set is greater than m proportion of the data size, removing all values that equal to the mode.

To ensure the best possible reduction where there can be multiple values responsible for a high kurtosis, the mode may be recomputed based on the reduced data set this step may be repeated until the mode of the data at hand has a cardinality lesser than m.

In some examples, step 501 comprises performing the step of removing values from the data set responsive to the data set have a size greater than a threshold size.

In other words, to prevent the possibility of removing too many be values form the data set, step 501 may comprise keeping a check on the current size of the data set to ensure it is within an acceptable size, n (for example, with a size of 30 being a reasonable default). Therefore, the removal of values may be performed is done recursively until either of the conditions “count of mₒ in X is >m|X|” or “|X|>n” breaks.

It will be appreciated that an array of elements to remove M, may be complied with all the removed elements so that the same elements can be removed during an inference phase (e.g. during step 506).

To illustrate, assume a data set which has a lot of 1s and 2s but nominal occurrences of 3 till 5 and anything above 5 is abnormal. Applying an outlier detection algorithm directly may flag all values above 3, thus more false positives. So, in this case, assuming m=0.5,
1. The initial mode mₒ=1,
2. The count of mₒ in X is >m|X|, i.e., the occurrences of the mode is greater an half of the size of X
3. |X|>n, i.e., the size of X is large enough, so all occurrences of 1 is removed from X and ‘1’ appended to the Mₒ list so that this number is also removed during inference
4. The next mode becomes mₒ=2.
5. The count of mₒ in X is >m|X|, i.e., the occurrences of m, is greater an half of the size of X
6. |X|>n, i.e., the size of X is large enough, so all occurrences of 2 is removed from X and ‘2’ appended to the Mₒ list so that this number is also removed during inference
7. Let the next mode be mₒ=4
8. Now, this mode is not as frequent in the data, i.e., the count of m, in X is not >m|X|. So the loop ends.

Step 502 comprises splitting the data into two tails. Step 502 comprises an example implementation of step 201 of FIG. 2. Step 502 may comprise responsive to a value in the data set being greater than a median of the data set, putting the value in the first tail of the data set, or responsive to a value in the data set being less than a median of the data set, putting the value as being in the first tail of the data set.

In other words, step 502 may comprise responsive to a value in the data set being greater than a median of the data set, putting the value in a right tail of the data set, or responsive to a value in the data set being less than a median of the data set, putting the value in the a left tail of the data set.

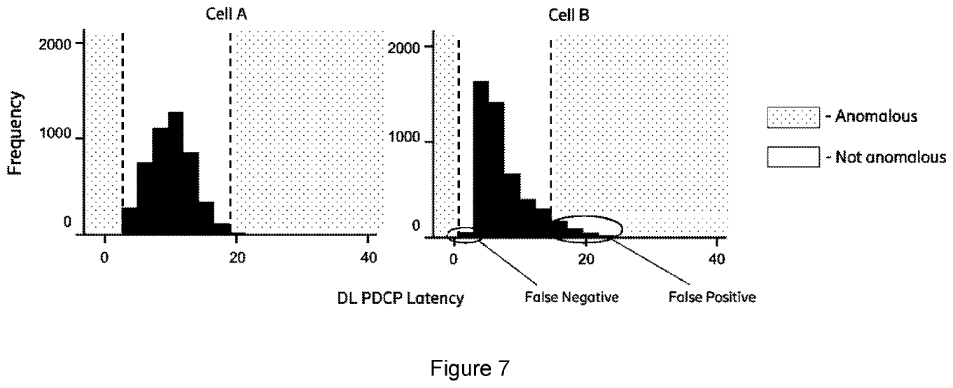

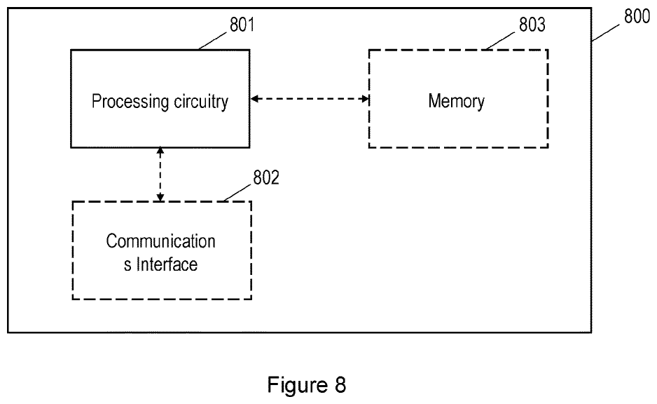

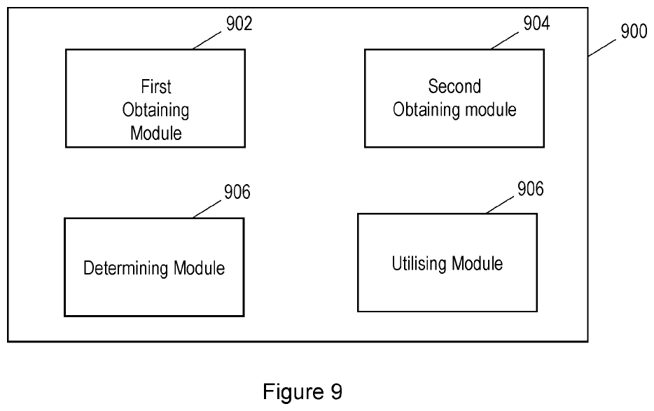

Addressing the skew in data is an open problem in anomaly detection. Central limit theorem states that a large sample size of finite variance can approximately follow a normal distribution (see for example, Fischer, H. (2011). A history of the central limit theorem: from classical to modern probability theory (pp. 1-10). New York: Springer). However, this approximation may not always work to favour anomaly detection systems in practice. For instance, FIG. 7 shows the distribution of a KPI called DL PDCP Latency of two different cells over 2 months. Cell A clearly shows a normal distribution wherein Cell B shows a distribution with a significant right skew. This can cause issues in determining the bounds to identify anomalies. A standard two-tailed threshold would lead to both false positives and false negatives. It will therefore be appreciated that the nature of skew can differ between one cell to another even considering the same KPI. The anomalous regions are marked from the perspective of a simple outlier detection algorithm that assumes the input data to be normally distributed, thus leading to false positives and false negatives.

Therefore, in some examples, step 502 comprises removing all values between Q₁ and Q₃, i.e., the first and third quartiles of the input data during training. This step removes the possible extreme skew produced by the median being lesser than the mean.

In these examples step 502 may comprise responsive to a value being in a lowest quartile of the data set (e.g., less than Q₁), putting the value in the first tail of the data set, or responsive to a value being in a highest quartile of the data set (e.g., greater than Q₃), putting the value in the first tail of the data set.

For example, step 502 may comprise responsive to a value being in a lowest quartile of the data set (e.g., less than Q₁), putting the value in the left tail of the data set, or responsive to a value being in a highest quartile of the data set (e.g., greater than Q₃), putting the value in a right tail of the data set.

In other words, step 502 may comprise splitting the data set, X, into its left and right tail constituents, i.e., Xₗ and Xᵣ respectively. If the reduce skew operation is applied, then all values less than Q₁ are in the left tail, and all values greater than Q₃ are in the right tail, the remaining values are removed. If the reduce skew operation is not applied, the median may be used as divider for the tails.

Data from both tails will undergo the rest of the flow separately. That is, separate mean, SD, threshold, and bounds will be defined for each tail. It will be appreciated that in some examples only data from one tail is analysed for anomalies.

In step 503, the mean μᵣ and standard deviation or of the right tail are calculated. The mean μₗ and standard deviation σₗ of the left tail are calculated.

In step 504, the upper threshold and lower thresholds are calculated by utilising the PPF of the standard normal function based on the upper percentile thresholds and lower percentile thresholds. Step 504 comprises an example implementation of step 203 of FIG. 2.

In step 505 the upper bound and lower bound are calculated based on the output of steps 503 and 504. Step 505 comprises an example implementation of step 401 of FIG. 4. The upper and lower bounds may then be used to analyse the anomalies in the data (e.g. as described with reference to FIG. 4).

In step 506 the Z-scores for each of the right tail and the left tail are calculated. Step 506 may be performed based on the output of step 503. In some circumstances the splitting and filtering of the tails may be recalculated based on the stored parameters such as the array of elements to remove Mₒ. Step 506 comprises an example implementation of step 301 of FIG. 3.

In step 507 the anomaly scores for each value are calculated. Step 507 comprises an example implementation of step 302 of FIG. 3. The anomaly scores may be utilised to determine whether a value is anomalous as described with reference to FIG. 4.

### Algorithm

The following example pseudocode written in italic text is an example pseudocode for the training and inference phases. In this example, it is assumed that the business case requires the identification of both right- and left-tailed anomalies. In cases that only a single tail is preferred or required, the steps that involve the other tail may be ignored. For instance, if the system only concerns right-tailed anomalies, then the computation of the left tail parameters may be ignored and vice versa. It will be appreciated that values that are filtered out (e.g., as described in steps 501 and 502 of FIG. 5) may be given an anomaly score of 0%.

Training Sequence

```
Input:
  • Parameters:
    ○ Data array, X
    ○ Boolean options: minimize_kurtosis, reduce_skew
  • Hyperparameters:
    ○ Percentile thresholds: lower_perc_thresh (default = 1),
      upper_perc_thresh (default = 99)
    ○ Mode elimination threshold: m (default = 0.5)
    ○ Minimum sample size: n (default = 30)
Output:
  • Mean and SD: μₗ, μᵣ, σₗ, σᵣ
  • Z thresholds: lower_threshold, upper_threshold
  • Bounds: lower_bound, upper_bound
  • Array of elements to remove: Mₒ
  • Split boundaries: Q₁ and Q₃, or \tilde{x}
Steps:
1. Start
2. If minimize_kurtosis is set
  2.1. Mₒ ← empty list
  2.2. Let mₒ ← mode(X)
  2.3. If the count of mₒ in X is > m|X| and |X| > n, then
    2.3.1. Remove all occurrences of mₒ from X
    2.3.2. Append mₒ to Mₒ
    2.3.3. Go to step 2.2
3. If reduce_skew is set and |X| > n, then
  3.1. Compute quartiles Q₁ and Q₃ from X
  3.2. Set left tail subset, Xₗ ← [s ϵ X | s < Q₁]
  3.3. Set right tail subset, Xᵣ ← [s ϵ X | s > Q₃]
4. If reduce_skew is not set, then
  4.1. Let \tilde{x} ← median(X)
  4.2. Set left tail subset, Xₗ ← [s ϵ X | s < \tilde{x}]
  4.3. Set right tail subset, Xᵣ ← [s ϵ X | s > \tilde{x}]
5. Extract the thresholds from the standard normal distribution
  5.1. upper_threshold = standard_normal_PPF (upper_perc_thresh)
  5.2. lower_threshold = standard_normal_PPF (lower_perc_thresh)
6. Right tail computation
  6.1. μᵣ ← mean(Xᵣ) and σᵣ ← standard_deviation(Xᵣ)
  6.2. upper_bound ← upper_threshold · σᵣ + μᵣ
7. Left tail computation
  7.1. μₗ ← mean(Xₗ) and σₗ ← standard deviation(Xₗ)
  7.2. lower_bound ← lower_threshold · σₗ + μₗ
8. Return (μᵣ, σᵣ, upper_bound, μₗ, σₗ, lower bound, \tilde{x}, Mₒ, Q₁, Q₃)
9. End
```

Inference Sequence

```
Input:
  • Parameters:
    ○ Data array, X
    ○ Boolean options: minimize_kurtosis, reduce_skew, cap_at_100
    ○ Mean and SD: μₗ, μᵣ, σₗ, σᵣ
    ○ Z thresholds: lower_threshold, upper_threshold
    ○ Elements to remove: Mₒ
    ○ Split boundaries: Q₁ and Q₃, or \tilde{x}
Output:
  • Anomaly scores in percentages
Steps:
1. Start
2. If minimize_kurtosis is set, then remove all occurrences of mₒ ϵ Mₒ
from X
3. If reduce_skew is set, then
  3.1. Set left tail subset, Xₗ ← [s ϵ X | s < Q₁]
  3.2. Set right tail subset, Xᵣ ← [s ϵ X | s > Q₃]
4. If reduce_skew is not set, then
  4.1. Set left tail subset, Xₗ ← [s ϵ X | s < \tilde{x}]
  4.2. Set right tail subset, Xᵣ ← [s ϵ X | s > \tilde{x}]
5. Right tail computation
  5.1. Zᵣ ← (Xᵣ − μᵣ)/σᵣ
  5.2. anomaly_scores ← 100 · Zᵣ/upper_threshold
6. Left tail computation
  6.1. Zₗ ← (Xₗ − μₗ)/σₗ
  6.2. anomaly_scoresₗ ← 100 · Zₗ/lower_threshold
7. Combine and postprocess
  7.1. anomaly_scores ← concatentenate(anomaly_scoresₗ, anomaly_
  scoresᵣ)
  7.2. Cap negative scores in anomaly_scores to 0
  7.3. If cap_at_100 is set, then cap scores > 100% in anomaly_scores
  to 100%
8. Return anomaly_scores
9. End
```

FIG. 8 illustrates an apparatus 800 comprising processing circuitry (or logic) 801. The processing circuitry 801 controls the operation of the apparatus 800 and can implement the method described herein in relation to an apparatus 800. The processing circuitry 801 can comprise one or more processors, processing units, multi-core processors or modules that are configured or programmed to control the apparatus 800 in the manner described herein. In particular implementations, the processing circuitry 801 can comprise a plurality of software and/or hardware modules that are each configured to perform, or are for performing, individual or multiple steps of the method described herein in relation to the apparatus 800. It will be appreciated that the apparatus 800 may comprise one or more virtual machines running different software and/or processes. The apparatus 800 may therefore comprise, or be implemented in or as one or more servers, switches and/or storage devices and/or may comprise cloud computing infrastructure that runs the software and/or processes.

Briefly, the processing circuitry 801 of the apparatus 800 is configured to obtain a first tail of the data set; obtain a first percentage threshold; determine a first threshold by inputting the first percentage threshold into a percent point function of a standard normal distribution; and utilise the first threshold to determine whether values in the first tail of the data set are anomalous.

In some embodiments, the apparatus 800 may optionally comprise a communications interface 802. The communications interface 802 of the apparatus 800 can be for use in communicating with other nodes, such as other virtual nodes. For example, the communications interface 802 of the apparatus 800 can be configured to transmit to and/or receive from other nodes requests, resources, information, data, signals, or similar. The processing circuitry 801 of apparatus 800 may be configured to control the communications interface 802 of the apparatus 800 to transmit to and/or receive from other nodes requests, resources, information, data, signals, or similar. The communications interface 802 can use any suitable communication technology.

Optionally, the apparatus 800 may comprise a memory 803. In some embodiments, the memory 803 of the apparatus 800 can be configured to store program code that can be executed by the processing circuitry 801 of the apparatus 800 to perform the method described herein in relation to the apparatus 800. Alternatively, or in addition, the memory 803 of the apparatus 800, can be configured to store any requests, resources, information, data, signals, or similar that are described herein. The processing circuitry 801 of the apparatus 800 may be configured to control the memory 803 of the apparatus 800 to store any requests, resources, information, data, signals, or similar that are described herein. The apparatus 800 may be configured operate in the manner described herein in respect of an apparatus.

FIG. 9 is a block diagram illustrating an apparatus 900 according to some embodiments. The apparatus 900 can determine anomalies in a data set of performance metrics from a network.

The apparatus 900 comprises a first obtaining module 902 configured to obtain a first tail of the data set. The apparatus 900 comprises a second obtaining module 904 configured to obtain a first percentage threshold. The apparatus 900 further comprises a determining module 906 configured to determine a first threshold by inputting the first percentage threshold into a percent point function of a standard normal distribution. The apparatus further comprises a utilising module 908 configured to utilise the first threshold to determine whether values in the first tail of the data set are anomalous. The apparatus 900 may operate in the manner described herein in respect of an apparatus.

There is also provided a computer program comprising instructions which, when executed by processing circuitry (such as the processing circuitry 801 of the apparatus 800 described earlier), cause the processing circuitry to perform at least part of the method described herein. There is provided a computer program product, embodied on a non-transitory machine-readable medium, comprising instructions which are executable by processing circuitry to cause the processing circuitry to perform at least part of the method described herein. There is provided a computer program product comprising a carrier containing instructions for causing processing circuitry to perform at least part of the method described herein. In some embodiments, the carrier can be any one of an electronic signal, an optical signal, an electromagnetic signal, an electrical signal, a radio signal, a microwave signal, or a computer-readable storage medium.

Some embodiments described herein remove highly frequent data from the distribution to reduce the effect of skew and kurtosis before being used to detect anomalies. Network KPI data may tend to be highly skewed and a normal distribution assumption may negatively affect anomaly detection methods.

The proposed thresholding method of embodiments described herein considers the universal possibilities of anomalous peaks and dips as opposed to typical dynamic thresholding methods that limit their understanding of anomalies to the dataset in the percept history. In some embodiments both the input threshold parameters and the output scores are intuitive and human readable. The end-user therefore need not to be a data scientist or a statistician to understand these values for the intended business purpose.

A simple outlier detector and scoring method has a lower computational and space complexity. The embodiments described herein may therefore scale well for larger datasets and have much better explainability compared to more complicated methods. In some embodiments bounds on the real data are provided so that the end user can clearly see which region anomalous and which region falls under the expected range.

Embodiments described herein may apply well to both IID (independent and identically distributed) and time series data.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A computer-implemented method for determining anomalies in a data set of performance metrics from a network, the method comprising:
obtaining a first tail of the data set;
obtaining a first percentage threshold;
determining a first threshold by inputting the first percentage threshold into a percent point function of a standard normal distribution; and
utilising the first threshold to determine whether values in the first tail of the data set are anomalous.

2. The method as claimed in claim 1 wherein the step of utilising the first threshold to determine whether values in the first data set are anomalous comprises:
determining Z-scores for the values in the first tail of the data set; and
for each value in the first tail:
calculating an anomaly score by dividing the Z-score for the value by the first threshold; and
responsive to the anomaly score being above an anomaly threshold value, determining that the value is anomalous.

3. The method as claimed in claim 1 wherein the step of utilising the first threshold to determine whether values in the first data set are anomalous comprises:
determining a first bound from: the first threshold, a standard deviation derived from the first tail of the data set, and a mean of the first tail of the data set; and
comparing the values in the first tail to the first bound.

4. The method as claimed in claim 1 further comprising:
obtaining a second tail of the data set;
obtaining a second percentage threshold;
determining a second threshold by inputting the second percentage threshold into a percent point function of a standard normal distribution; and
utilising the second threshold to determine whether values in the second tail of the data set are anomalous.

5. The method as claimed in claim 1 further comprising:
reducing kurtosis in the data set before obtaining the first tail of the data set.

6. The method as claimed in claim 5 wherein the step of reducing kurtosis in the data set comprises:
a) responsive to the cardinality of a mode in the data set being greater than a mode elimination threshold proportion of the data set, removing values from the data set equal to the mode to generate a reduced data set.

7. The method as claimed in claim 6 further comprising:
setting the reduced data set as the data set and repeating step a).

8. The method as claimed in claim 6 further comprising:
performing the step of removing values from the data set responsive to the data set have a size greater than a threshold size.

9. The method as claimed in claim 1 wherein the step of obtaining the first tail comprises:
responsive to a value in the data set being greater than a median of the data set, putting the value in the first tail of the data set, or
responsive to a value in the data set being less than a median of the data set, putting the value as being in the first tail of the data set.

10. The method as claimed in claim 1 wherein the step of obtaining the first tail of the data set comprises:
responsive to a value being in a lowest quartile of the data set, putting the value in the first tail of the data set, or
responsive to a value being in a highest quartile of the data set, putting the value in the first tail of the data set.

11. The method as claimed in claim 1 further comprising:
responsive to determining that a number of anomalies in the first tail of the data set has increased, initiating an identification of the cause of the increase.

12. The method as claimed in claim 1 further comprising:
analysing a number of anomalies in the first tail of the data set to determine whether a cell in the network is inactive or sleeping.

13. The method as claimed in claim 1 further comprising:
responsive to determining that a number of anomalies in the first tail of the data set has increased, determining that a malicious attack has occurred in the network.

14. The method as claimed in claim 1 further comprising:
responsive to determining that a number of anomalies in the first tail of the data set has increased, adjusting one or more network configuration parameters.

15. An apparatus for determining anomalies in a data set of performance metrics from a network, the apparatus comprising processing circuitry configured to cause the apparatus to:
obtain a first tail of the data set;
obtain a first percentage threshold;
determine a first threshold by inputting the first percentage threshold into a percent point function of a standard normal distribution; and
utilise the first threshold to determine whether values in the first tail of the data set are anomalous.

16. The apparatus as claimed in claim 15 wherein the processing circuitry is further configured to perform a computer-implemented method for determining anomalies in a data set of performance metrics from a network, the method comprising:
obtaining a first tail of the data set;
obtaining a first percentage threshold;
determining a first threshold by inputting the first percentage threshold into a percent point function of a standard normal distribution; and
utilising the first threshold to determine whether values in the first tail of the data set are anomalous, wherein the step of utilising the first threshold to determine whether values in the first data set are anomalous comprises:
determining Z-scores for the values in the first tail of the data set; and
for each value in the first tail:
calculating an anomaly score by dividing the Z-score for the value by the first threshold; and
responsive to the anomaly score being above an anomaly threshold value, determining that the value is anomalous.

17. A computer program comprising instructions which, when executed on at least one processor, cause the at least one processor to carry out a method according to claim 1.
